(19) United States
(12) Patent Application Publication
(10) Pub. No.: US 2024/0240437 A1
(43) Pub. Date: Jul. 18, 2024

(54) GROUND ENGAGING TOOL CONTROL SYSTEM

(71) Applicant: Deere & Company, Moline, IL (US)

(72) Inventors: Alexander M. Mork, West Fargo, ND (US); Michael L. Rhodes, Richfield, MN (US)

(21) Appl. No.: 18/153,452

(22) Filed: Jan. 12, 2023

(51) Int. Cl. E02F 9/26; A01B 76/00

(52) U.S. Cl. CPC E02F 9/264; A01B 76/00; E02F 9/267; A01B 3/26

(57) ABSTRACT

An agricultural or construction implement comprises an implement frame. A ground engaging tool is coupled to the implement frame. A control system comprises a sensor that is positioned adjacent to the ground engaging tool. The sensor is configured for providing a signal indicative of a ground engaging tool status. A controller is communicatively coupled to the sensor. The controller comprises a data storage device and an electronic data processor. The data storage device is configured for storing instructions that are executable by the electronic data processor to cause the electronic data processor to receive the signal, determine the ground engaging tool status, and provide a signal to an operator.

### FIELD OF THE DISCLOSURE

The present disclosure generally relates to agricultural and construction implements and more particularly to a ground engaging tool control system for an agricultural or construction implement.

### BACKGROUND OF THE DISCLOSURE

In order to verify that a ground engaging tool is operating properly, an operator commonly has to visually inspect each ground engaging tool. For example, an operator would need to stop the agricultural or construction implement and check each ground engaging tool to ensure that it is not tripped, broken, or missing.

### SUMMARY OF THE DISCLOSURE

In one embodiment, an agricultural or construction implement is disclosed. The implement comprises an implement frame. A ground engaging tool is coupled to the implement frame. A control system comprises a sensor that is positioned adjacent to the ground engaging tool. The sensor is configured for providing a signal indicative of a ground engaging tool status. A controller is communicatively coupled to the sensor. The controller comprises a data storage device and an electronic data processor. The data storage device is configured for storing instructions that are executable by the electronic data processor to cause the electronic data processor to receive the signal, determine the ground engaging tool status, and provide a signal.

In another embodiment, an agricultural or construction implement coupled to a work vehicle is disclosed. The agricultural or construction implement comprises an implement frame. A ground engaging tool is coupled to the implement frame. A control system comprises a sensor positioned adjacent the ground engaging tool. The sensor is configured for providing a signal indicative of a ground engaging tool status. A controller is communicatively coupled to the sensor, the controller comprises a data storage device and an electronic data processor. The data storage device is configured for storing instructions that are executable by the electronic data processor to cause the electronic data processor to receive the signal, determine the ground engaging tool status, and provide a signal. Wherein, if the data processor determines that the ground engaging tool status is that the agricultural or construction implement is inoperable, the electronic data processor provides a signal to the work vehicle to stop the agricultural or construction implement from operating.

In yet another embodiment, a method for controlling an agricultural or construction implement is disclosed. The agricultural or construction implement comprises an implement frame and a ground engaging tool coupled to the implement frame. The method comprises receiving a signal indicative of a ground engaging tool status, determining the ground engaging tool status, and providing a signal.

Other features and aspects will become apparent by consideration of the detailed description and accompanying drawings.

### BRIEF DESCRIPTION OF THE DRAWINGS

FIG. 1 is a perspective view of a construction work vehicle comprising an implement according to one embodiment;

FIG. 2 is a side view of a construction work vehicle comprising an implement according to another embodiment;

FIG. 3 is a side view of an agricultural work vehicle comprising an implement according to yet another embodiment;

FIG. 4 is a schematic of a control system; and

FIG. 5 is a flow chart of a method of controlling the implement of FIGS. 1-3.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

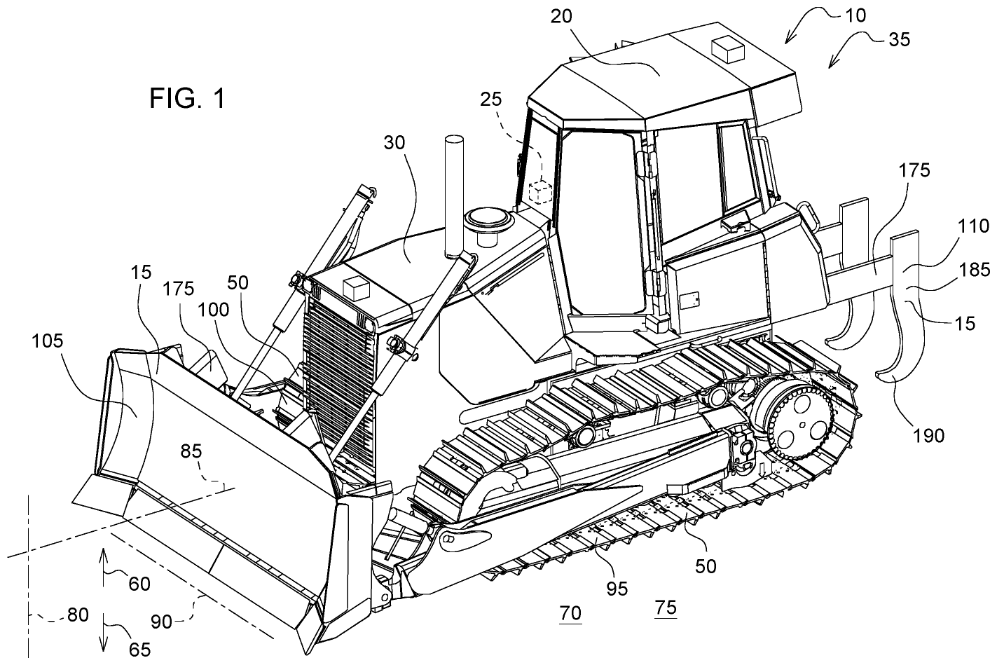

FIGS. 1-3 illustrate a work vehicle 10 having an implement 15, an operator station 20 having an operator interface 25, and an engine 30. The work vehicle 10 may be any work vehicle 10 to which the implement 15 maybe coupled for movement with the work vehicle 10, such as a crawler 35, a motor grader 40, or a tractor 45 to name a few examples. The implement 15 maybe attached directly to the work vehicle 10 or towed behind the work vehicle 10. The work vehicle 10 may be controlled by an operator located in the operator station 20 or by an operator located at a remote location (not shown) from the work vehicle 10. The operator may command the work vehicle 10 to move forward, move backward, and turn. Those commands are sent to hydraulic pumps, driven by the engine 30, which direct pressurized hydraulic fluid to hydraulic motors that turn tracks 50 or wheels 55. The engine 30 maybe a diesel engine. Alternatively, the tracks 50 or wheels 55 maybe turned by electric motors.

Referring to FIG. 1, the implement 15 maybe positioned at a front of the work vehicle 10 and may be attached to the work vehicle 10 in a number of different manners. In this embodiment, the implement 15, or an implement frame 175, may be attached to the work vehicle 10 through a linkage which includes a series of pinned joints, structural members, and hydraulic cylinders. This configuration allows the implement 15 to be moved up 60 and down 65 relative to a ground material 70 of a worksite 75, rotate around a vertical axis 80 (i.e., an axis normal to the ground), rotate around a longitudinal axis 85 (e.g., a fore-aft axis of the work vehicle 10), and rotate around a lateral axis 90 of the work vehicle 10 (i.e., a left-right axis of the work vehicle 10). These degrees of freedom permit the implement 15 to engage the ground material 70 at multiple depths and cutting angles. Alternative embodiments may involve implements 15 with greater degrees of freedom, such as those found on some motor graders 40, and those with fewer degrees of freedom, such as “pushbeam” style blades found on some crawlers 35 and implements 15 which may only be raised, lowered, and rotated around a vertical axis as found on some excavators and skidders, and implements 15 that are attached to other locations of the work vehicle 10 (e.g., rear).

The operator may command movement of the implement 15 from the operator station 20, which may be coupled to the work vehicle 10 or located remotely. In the case of the work vehicle 10, those commands are sent, including mechanically, hydraulically, and/or electrically, to a hydraulic control valve. The hydraulic control valve receives pressurized hydraulic fluid from a hydraulic pump, and selectively sends such pressurized hydraulic fluid to a system of hydraulic cylinders based on the operator's commands. The hydraulic cylinders, which in this case are double-acting, in the system are extended or retracted by the pressurized fluid and thereby actuate the implement 15. Alternatively, electronic actuators may be used.

With continued reference to FIG.1, the illustrated work vehicle 10 is a crawler 35 for moving the ground material 70. The crawler 35 includes tracks 50 including a left track 95 and a right track 100. As used herein, “left” and “right” refer to the left and right sides of the operator when the operator is sitting within the operator station 20 that is coupled to the work vehicle 10 and facing the illustrated implement 15. The illustrated implement 15 is a blade 105. Alternatively, it is contemplated that the implement 15 maybe a bucket (not shown) or other attachment coupled to a wheel loader (not shown). One such implement 15 is a ripper 110 that is attached to a rear of the work vehicle 10 via the implement frame 175. The ripper 110 is a ground engaging tool 185 that comprises a ripper shank 190.

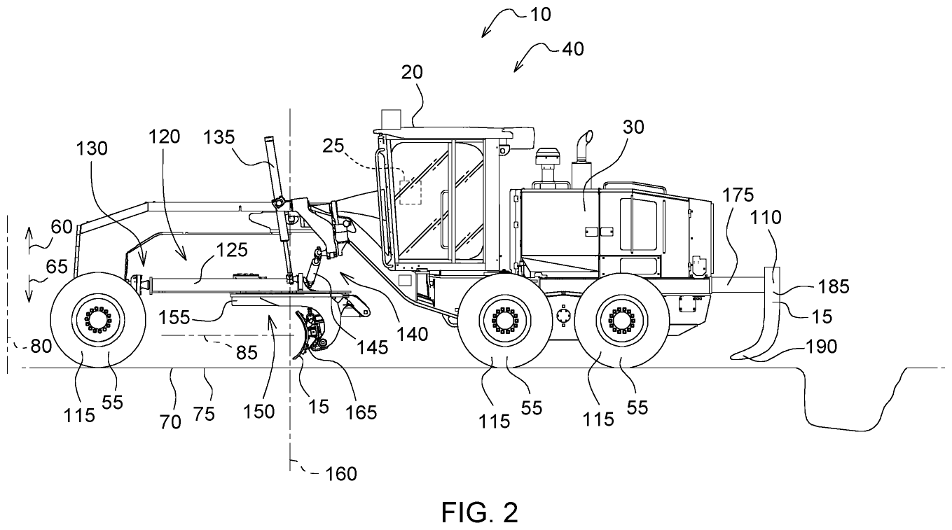

Referring to FIG. 2, the illustrated work vehicle 10 is a motor grader 40 for spreading and leveling dirt, gravel, or other ground material 70. The motor grader 40 includes wheels 55 including a plurality of left wheels 115 (right wheels not shown). A drawbar assembly 120 or draft frame is coupled to the work vehicle 10. A drawbar 125 of the drawbar assembly 120 is mounted to a front location 130 of the work vehicle 10. Left and right actuators 135 support the drawbar 125. The left and right actuators 135 either raise or lower the drawbar 125. A side shift linkage arrangement 140 is coupled to the drawbar 125 and includes a side swing hydraulic actuator 145.

A circle drive assembly 150, or implement frame 175, is coupled to the drawbar assembly 120. The circle drive assembly 150 can include a rotatable circle member 155 coupled to the draft frame or drawbar assembly 120. The circle drive assembly 150 can be rotatable about a rotation axis 160 in a clockwise or counterclockwise direction.

The illustrated implement 15 is a moldboard 165 that is coupled to the circle drive assembly 150 of the work vehicle 10 and configured to move the ground material 70 on the worksite 75. While a moldboard 165 is described herein, other types of implements 15 are contemplated by this disclosure. For example, a ripper 110 is attached to a rear, opposite of the front location 130, of the work vehicle 10. The ripper 110 is a ground engaging tool 185 that comprises a ripper shank 190.

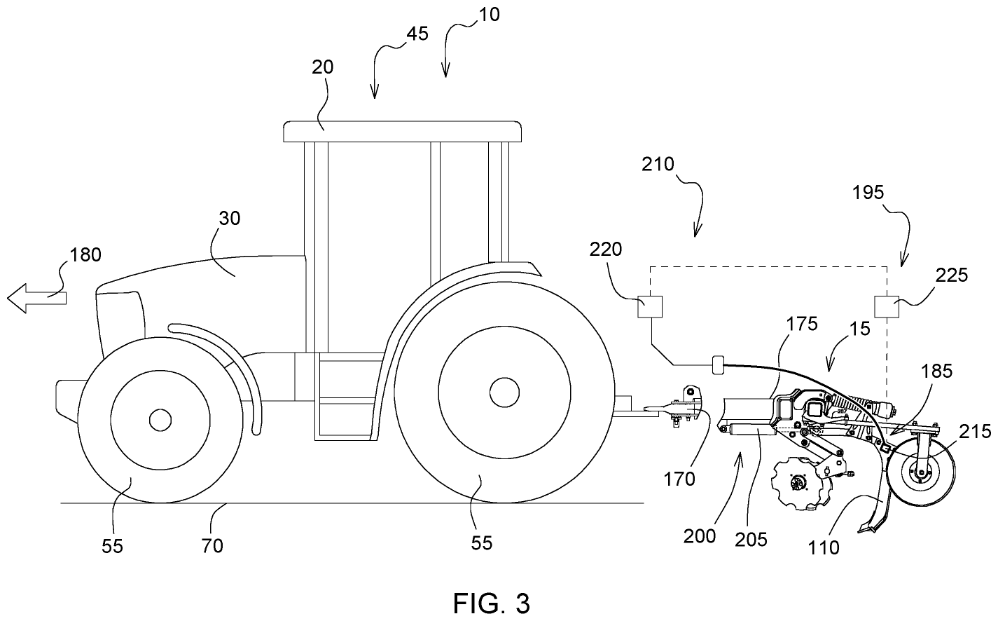

FIG. 3 illustrates a work vehicle 10 having an implement 15 according to another embodiment. The illustrated work vehicle 10 is an agricultural tractor 45. The illustrated implement 15 is a tillage implement 195.

The tillage implement 195 includes a coupling mechanism 170 for coupling to the work vehicle 10. An implement frame 175 is coupled to the coupling mechanism 170. The implement frame 175 extends rearwardly from the coupling mechanism 170 in a direction opposite of a direction of travel 180. A ground-engaging tool 185 is coupled to the implement frame 175. Additional ground-engaging tools 185 may be coupled to the implement frame 175. The illustrated ground-engaging tool 185 is the ripper 110. Other ground-engaging tools 185 (e.g., disks, openers) are contemplated by this disclosure including a tillage shank, a rolling basket, and a disk. A plurality of wheel assemblies (not shown) are coupled to the implement frame 175 to support the implement frame 175 above the ground material 70.

An adjustment device 200 is coupled to the ground-engaging tool 185. The illustrated adjustment device 200 is an extendable and retractable hydraulic actuator 205. Alternatively, the adjustment device 200 may be an electric actuator, pneumatic cylinder, or other similar device. Additional adjustment devices 200 may be coupled to additional ground-engaging tools 185 for individual control thereof.

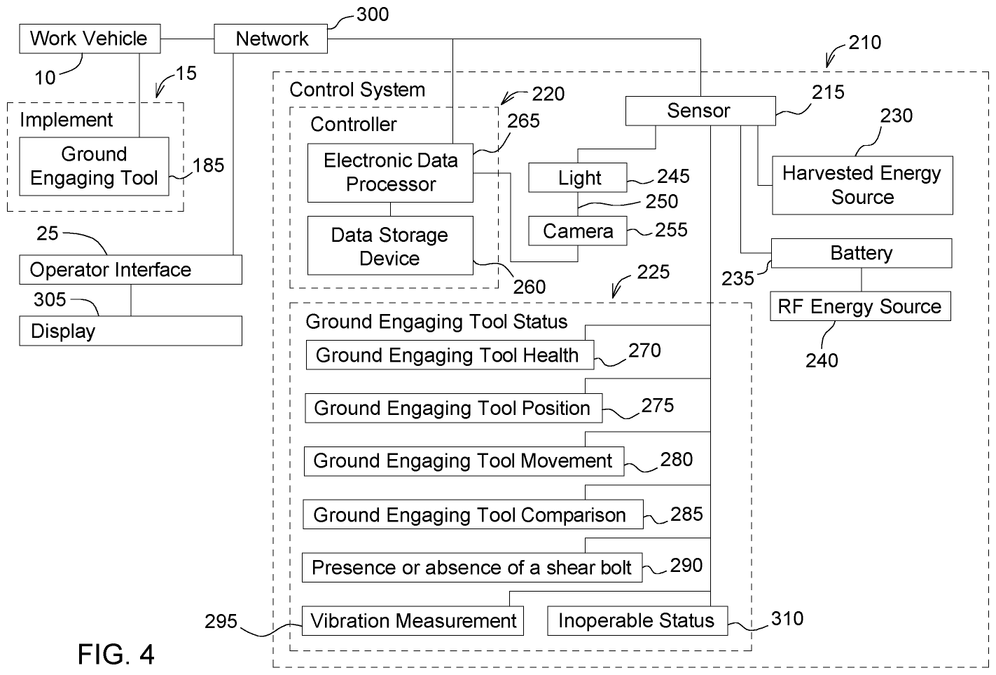

With continued reference to FIG. 3 and reference to FIG. 4, a control system 210 is provided. The control system 210 comprises a sensor 215 and a controller 220. The sensor 215 is positioned adjacent or near the ground engaging tool 185 and is configured to provide a signal indicative of a ground engaging tool status 225. Alternatively, the sensor 215 may be coupled to the ground engaging tool 185 or positioned on the work vehicle 10. The sensor 215 may be a camera, a lidar, a radar, a vibration sensor, a mechanical sensor, or other type of sensor 215 that is positioned near or has a view of the ground engaging tool 185.

The sensor 215 further comprises a harvested energy source 230, or a battery 235, configured for providing electrical power to the sensor 215. The battery 235 may be configured to be charged by an RF energy source 240 coupled to the agricultural or construction implement 15. The battery 235 may also be charged by the work vehicle 10 electrical system or by other means.

The sensor 215 may comprise a light 245 and the signal may comprise a visual indicator 250 (e.g., light color, light flashing frequency) that is received by a camera 255 communicatively coupled to the controller 220. Alternatively, the sensor 215 may communicate with the controller 220 via a network 300 comprising at least one of a wired or wireless connection.

The controller 220 comprises a data storage device 260 and an electronic data processor 265. The data storage device 260 is configured for storing instructions that are executable by the electronic data processor 265 to cause the electronic data processor 265 to receive the signal, determine the ground engaging tool status 225, and provide a signal indicative of the ground engaging tool status 225 to an operator via the operator interface 25, or a display 305, or to change an operation of the implement 15 and/or work vehicle 10, or automatically change an implement setting or to stop the implement 15 and/or work vehicle 10. The operation or implement setting may be the speed with which the implement 15 is moving with the work vehicle 10, an operating height of the implement 15 relative to the ground material 70 of a worksite 75, a depth of the ground engaging tool 185 in the ground material 70, the position of the adjustment device 200, the position of the circle drive assembly 150, the position of the side shift linkage arrangement 140, the position of the left and right actuators 135, the position of the ripper 110, the position of the blade 105, the position of the moldboard 165, or the direction of travel 180 of the work vehicle 10.

In operation, if the electronic data processor 265 determines that the ground engaging tool status 225 is that the agricultural or construction implement 15 is an inoperable status 310, the electronic data processor 225 may provide a signal to the work vehicle 10 to stop the agricultural or construction implement 15 from operating.

The ground engaging tool status 225 comprises at least one of a ground engaging tool health 270, a ground engaging tool position 275, a ground engaging tool movement 280, or a ground engaging tool comparison 285. The ground engaging tool status 225 also may comprise the presence or absence of a shear bolt 290 or a vibration measurement 295.

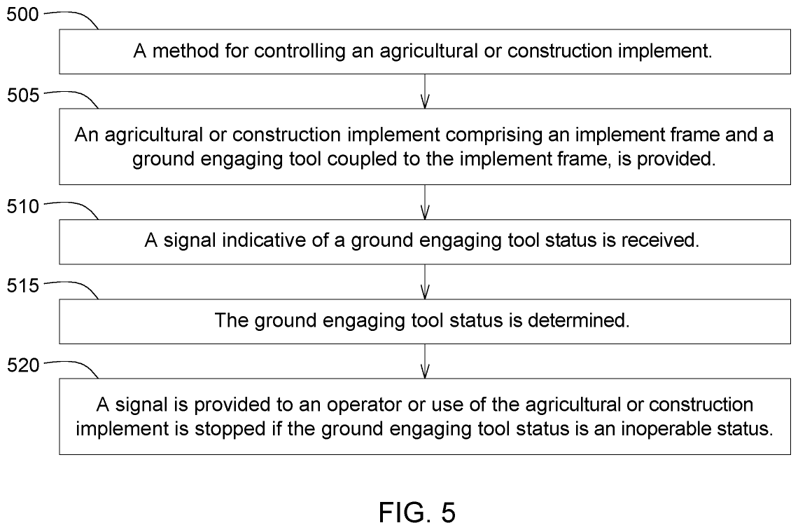

Referring now to FIG. 5, a flow diagram of a method 500 for controlling an agricultural or construction implement 15 is provided. At 505, an agricultural or construction implement 15 comprising an implement frame 175 and a ground engaging tool 185 is coupled to the implement frame 175, is provided. At 510, a signal indicative of a ground engaging tool status 225 is received. At 515, the ground engaging tool status 225 is determined. At 520, a signal is provided to an operator or use of the agricultural or construction implement 15 is stopped if the ground engaging tool status 225 is an inoperable status 310.

Various features are set forth in the following claims.

What is claimed is:

1. An agricultural or construction implement comprising:
an implement frame;
a ground engaging tool coupled to the implement frame; and
a control system comprising;
a sensor positioned adjacent the ground engaging tool, the sensor configured for providing a signal indicative of a ground engaging tool status; and
a controller communicatively coupled to the sensor, the controller comprising a data storage device and an electronic data processor, the data storage device configured for storing instructions that are executable by the electronic data processor to cause the electronic data processor to receive the signal, determine the ground engaging tool status, and provide a signal indicative of the ground engaging tool status or change an operation of the agricultural or construction implement.

2. The agricultural or construction implement of claim 1, wherein the agricultural or construction implement is coupled to a work vehicle for movement and if the data processor determines that the ground engaging tool status is an inoperable status, the electronic data processor provides a signal to the work vehicle to stop the agricultural or construction implement from operating.

3. The agricultural or construction implement of claim 1, wherein the ground engaging tool status comprises at least one of an inoperable status, a ground engaging tool health, a ground engaging tool position, a ground engaging tool movement, or a ground engaging tool comparison.

4. The agricultural or construction implement of claim 1, wherein the sensor further comprises a harvested energy source configured for providing electrical power to the sensor.

5. The agricultural or construction implement of claim 1, wherein the agricultural or construction implement comprises a tillage implement and the ground engaging tool comprises a tillage shank, a rolling basket, or a disk.

6. The agricultural or construction implement of claim 2, wherein the work vehicle comprises a motor grader, the agricultural or construction implement comprises a ripper, and the ground engaging tool comprises a ripper shank.

7. The agricultural or construction implement of claim 1, wherein the sensor comprises a light and the signal comprises a visual indicator that is received by a camera communicatively coupled to the controller.

8. The agricultural or construction implement of claim 1, wherein the ground engaging tool status comprises the presence or absence of a shear bolt.

9. The agricultural or construction implement of claim 1, wherein the sensor communicates with the controller via at least one of a wired or wireless connection.

10. An agricultural or construction implement coupled to a work vehicle, the agricultural or construction implement comprising:
an implement frame;
a ground engaging tool coupled to the implement frame; and
a control system comprising;
a sensor positioned adjacent the ground engaging tool, the sensor configured for providing a signal indicative of a ground engaging tool status; and
a controller communicatively coupled to the sensor, the controller comprising a data storage device and an electronic data processor, the data storage device configured for storing instructions that are executable by the electronic data processor to cause the electronic data processor to receive the signal, determine the ground engaging tool status, and provide a signal to an operator;
wherein if the data processor determines that the ground engaging tool status is an inoperable status, the electronic data processor provides a signal to the work vehicle to stop the agricultural or construction implement from operating.

11. The agricultural or construction implement of claim 10, wherein the ground engaging tool status further comprises at least one of a ground engaging tool health, a ground engaging tool position, a ground engaging tool movement, or a ground engaging tool comparison.

12. The agricultural or construction implement of claim 10, wherein the sensor further comprises a battery configured for providing electrical power to the sensor.

13. The agricultural or construction implement of claim 10, wherein the agricultural or construction implement comprises a tillage implement, the work vehicle comprises a tractor, and the ground engaging tool comprises a tillage shank.

14. The agricultural or construction implement of claim 10, wherein the work vehicle comprises a motor grader, the agricultural or construction implement comprises a ripper, and the ground engaging tool comprises a ripper shank.

15. The agricultural or construction implement of claim 10, wherein the sensor comprises a light and the signal comprises a visual indicator that is received by a camera communicatively coupled to the controller.

16. The agricultural or construction implement of claim 10, wherein the ground engaging tool status comprises a presence or absence of a shear bolt.

17. The agricultural or construction implement of claim 10, wherein the sensor communicates with the controller via at least one of a wired or wireless connection.

18. The agricultural or construction implement of claim 10, wherein the ground engaging tool status comprises a vibration measurement.

19. The agricultural or construction implement of claim 10, wherein the sensor is coupled to the ground engaging tool.

20. A method for controlling an agricultural or construction implement, the agricultural or construction implement comprising an implement frame and a ground engaging tool coupled to the implement frame, the method comprising:
receiving a signal indicative of a ground engaging tool status;
determining the ground engaging tool status; and
providing a signal to an operator or stopping use of the agricultural or construction implement.
